(19) United States
(12) Patent Application Publication
(10) Pub. No.: US 2003/0222814 A1
(43) Pub. Date: Dec. 4, 2003

(54) Global radiolocalization system

(76) Inventor: Gines Sanchez Gomez, Mostoles (Madrid) (ES)

Correspondence Address: Gines SANCHEZ GOMEZ, Calle Cervantes, 1, 70, B, Mostoles (Madrid), 28932, ES

(21) Appl. No.: 10/446,479

(22) Filed: May 23, 2003

(30) Foreign Application Priority Data
Jun. 3, 2002 (ES) P200201304

(51) Int. Cl. H04B 7/185

(52) U.S. Cl. 342/357.01

(57) ABSTRACT

Three satellites R1, R2 y R2 emit continously synchronized signals, each signal containing the position and the time of the emitter satellite, X a receiver with unknown position but with known altitude regarding the sea top, X receives the signals from R1, R2 y R3, with the measures R1-R2, R2-R3 y R3-R1, X obtains three revolution hyperboloids and a sphere with the earth center and radius the earth radius increased in said altitude, X calculates a tangent sphere to the four surfaces, being the center of the tangent sphere the X position.

### CROSS-REFERENCE TO RELATED APPLICATIONS

The present invention is based in the Spanish application for patent no. P200201304 dated Jun. 3, 2002, that is priority. The following patents are related with this invention:

EP0810449 improves the measures of the GPS with the Loran-C.

U.S. Pat. No. 6,032,902 about non-geostatationary constellations of satellites.

GB2380626, a terrestrial base sends a synchronization signal to a geostationary satellite, this geostationary satellite sends again said signal to some satellites placed on middle orbits, and these last satellites send again the signal the terrestrial base to correct the initial signal.

### BACKGROUND OF THE INVENTION

The hyperbolical navigation systems Loran and Omega are adapted the satellite navigation according the new tecniques about the process of the digital signals.

### BRIEF SUMMARY OF THE INVENTION

The satellites R1, R2 y R3 are provided with radiostations to send the digital signals F1, F2 y F3 on the frecuencies f1, f2 y f3. Each satellite is placed on an orbit of radius equal to the geostationary satellites, having the plane of the satellite orbit an angle less that 90° and more that 9° regarding the equator of the earth. In this case, the movement of the satellite in relation with the earth is shows as a regular movement as a “8”, raising/falling between +/− a maximal latitude (maximal latitude of the satellite), around an average meridian (longitude of the satellite). The three signals F1, F2 y F3 are synchronized, each signal having the following fields:

IE emission identifier,

IT emitter geography coordinates,

T emitter local time,

RS emitter delay of synchronization,

IR emission delay.

The global emision time of the signal from Ri is:

TEi=Ti+RSi+IRi

A satellite j is synchronized by j by calculating

RSj=Ti+RSi+IRi+|ITi−ITj|/c−tji

being:

|ITi-ITj|: distance between Ri and Rj,

t21: time of arrival of the signal Fi from Si to Sj, this time being measured with the clock of Sj (Sj local time).

A mobile X receives the signals F1, F2 y F3 at the times tx1, tx2 y tx3 (X local time) obtaining (IT1,TE1), (IT2,TE2) y (IT3,TE3). The distances between X and R1, R2 and R3 are:

dxi=(txi+RSx−TEi)/c (i=1, 2, 3),

RSx: the delay of synchronization of X (unknown)

being the distance differences:

dxi−dxj=(txi−txj)/c−(TEi−TEj)/c (i y j=1, 2, 3).

Each Ri, Rj and dxi-dxj defines a revolution hyperboloid Hij. X is located near said Hij.

X measures its altitude Hx regarding the sea top (for example with a altimeter).

The center of the earth and the radius of the earth+Hx define a sphere Ex. X is located near said Ex.

With three signals are obtained 3.2/(1.2)=3 hyperboloids, having the next equation systems:

H12, H23, Ex.

H23, H31, Ex,

H12, H31, Ex,

another solution could be the center of a tangent sphere of minimal radius to the four surfaces H12, H23, H31, Ex. Total solutions 4.

With four signals are obtained 4.3/(1.2)=6 hyperboloids, having the next equation systems:

| | |
|---|---|
| H12, H12, H34, | |
| . . . | (6.5.4)/(1.2.3)=20, |
| H12, H23, Ex, | |
| . . . | (6.5)/(1.2)=15, |
| tangent spheres: | 7.6.5.41(1.2.3.4)=35 |
| Total solutions 70. | |

Each solutions is an valuation of the position of X. The average of said valuation is a better valuation of X.

It is possible to obtain more that a solution for each equation system (also it is possible no solution). For each equation system, to pick up the correct solution is need having in account the sign of the dxi-dxj

if dxi-dxj<0, the correct solution is more near Ri that Rj,

if dxi-dxk<0, the correct solution is more near Ri that Rk,

. . .

Knowing X its position, X can synchronizes itself as a satellite Si, according the equation

RSx=Ti+RSi+IRi+|ITi−ITx|/c−txi,

from this point to lost the synchronization X can obtain distances to the satellites Ri, changing the hyperboloids by spheres.

Each signal Fi is obtained by sequencing the parallel bits of IEi, . . . , IRi with a pulse clock of period TM. The field T is obtained from a pulse clock of period TT, being TM>>TT.

$$TT is a fraction {2}^{m} of TM ( m > 1 ) .$$

This binary signal Fi is amplified, modulated in the frequency fi and emitted.

Each receiver (Rj or X) tunes the frequency fi, this signal, demodulated and amplified, returns the signal Fi, then being sampled by a clock of period TM.

The range of time between the start time of IEi and the sampling time is measured for subtract of TEi. By this, being 10 the two last bits of IEi, a clock counter RRj is actuated by the pulses TT, being started by the penultimate bit of IEi and being stoped by the last bit of IEi. The pulses TT actuate the counter RRj through an AND door, being other entry of said door the signal Fi.

A receiver delay RRRj could be regarded.

So, the signal Fi enters in Sj or X at the time

TEi+|ITi−ITj|/c−(TM−RRj) in global time

or

tj2+RRRj int local time (in Sj or X)

o similarly:

TEi+|ITi−ITj|/c in global time

tij=tj2+RRRj+(TM−RRj) in local time (in Sj or X).

Also, the process of the signal Fi could be made for a computer provided with a modem for receiving (in Si and X) and another modem for emitting (in Si) if the internal clock of the computer could produce pulses of period TT and the receiving modem could measure RRj. By this, the receiving modem is modified by adding a counter RRjk and a serial port to receive the pusles TT from the computer. The counter is actuated by the pulses TT and the signal Fi through an AND door, starting with the pulses TM of the modem. The value RRjk is transmited the computer through a parallel port.

Between the 9° Nort and the maximal latitude of the satellites ever must be three satellites to be visible the Nort Pole. Three more satellites are need between the 9° South and the minimal latitude of the satellite (=-the maximal latitude), three more between the minimal and the maximal latitude raising and three more between the minimal and the maximal latitude falling. A suitable maximal latitude would be the intermediate latitude between 18° and 90°=54°.

A structure could be four constellation of satellites, each constellation comprising three/four equidistant satellites in longitude, all the satellites of the same constellation having the same latituded at each time. The constellations are intercalated in the way which all the satellites are equidistant in longitude.

Each satellite emittes a signal, and said satellite receives another signal from the satellite more near in longitude.

Any satellites could be synchronized by terrestrial radiostations.

If the case is 3 satellites/constellation (total 12 satellites) 12 frequencies are need, if the case is 4 satellites/constellation (total 16 satellites), 16/2=8 frequencies are need because for each satellite there is another satellite symmetrical regarding the earth center.

Ending, it is possible which all or some satellites j could be radiorepeater of a signal Fjt from a terrestrial radiostation t. In this case, the terrestrial radiostation sends the satellite the fields IE, . . . IR, according the next:

ΔT: transit time of the radiolocalization signal from the terrestrial radiostation

t to the satellite radiorepeater j,

Rj(T): function to obtain the satellite position j at the time T,

ΔT is calculates according to:

|Rj(Tt+ΔT)−ITt|=c.ΔT

the fields IT y T are calculated according to:

ITj=Rj(Tt+ΔT)Tj=Tt+ΔT.

The terrestrial radiostation could be sincronized with the radiolocalization signal from the satellites, o with syncrhonizing signals from another terrestrain radiostation, in this last case, the syncrhonizing signals are also radiolocalization signal, and so could be used.

The previous paragraph permits to use comunication and television satellites for radiolocalization.

### BRIEF DESCRIPTION OF THE FIGURES

FIG. 1. Signals from the radiolocalization system.

FIG. 2. Geometrical problem to obtain a hyperboloid.

FIG. 3. Synchronization circuit of a satellite.

FIG. 4. Formation circuit of the satellite signal.

FIG. 5. Data captator circuit of a mobile.

FIG. 6. Pulses divider circuit.

FIG. 7. Signal identifier circuit.

FIG. 8. Basic comparator circuit.

FIG. 9. The computer-controlled system.

FIG. 10. Satellite sky projection.

FIG. 11. The movement of the satellite regarding the earth.

FIG. 12. Satellite fleet with 3 satellites/constellation.

FIG. 13. Signals from the radiolocalization system for radiorepeater satellites.

The representation of the logical doors are as following:

AND: triangle with several entrances and one exit,

OR: semicircle with several entrances and one exit,

NOT: triangle with one entrance and one exit,

### DETAILED DESCRIPTION OF THE INVENTION AND FIGURES

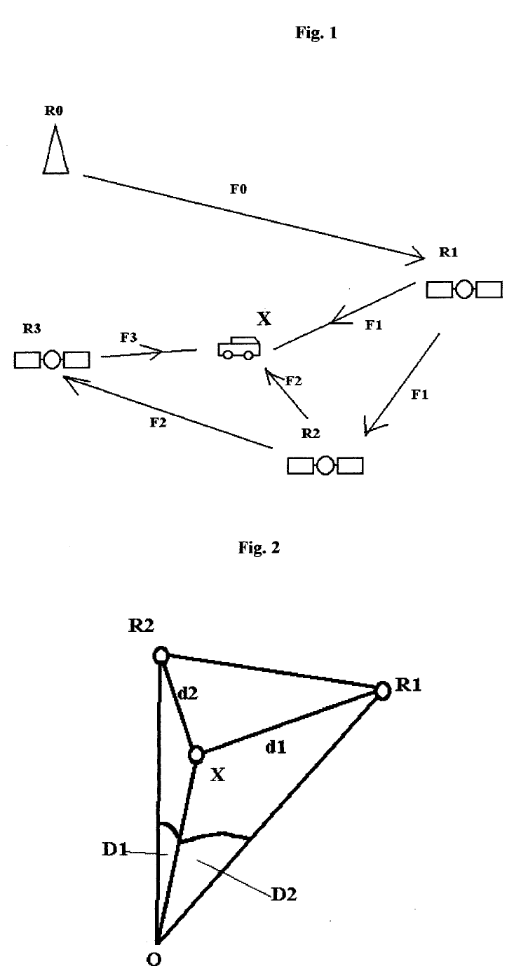

FIG. 1. Signals from the radiolocalization system.

The terrestrial radiostation R0 emits the synchronization signal F0 (as a radiolocalization signal) and the satellites R1, R2 y R3 emit the radiolocalization signals F1, F2 y F3. R1 continually receives the signal F0 being used as one synchronization signal, R2 continually receives the signal F1 being used as one synchronization signal, likewise R3 continually receives the signal F2 as synchronization signal and successively . . .

The mobile X to obtain its position, successively selects the frequencies of the signal F1, F2 y F3, obtaining the hyperboloids H12, H13, . . .

FIG. 2. Geometrical problem to obtain a hyperboloid.

O is the earth center.

R1 (r1,l1,L1) (known)

R2 (r2,l2,L2) (known)

X (rx,lx,Lx) (unknown)

r: radius from O, l: latitude, L: longitude (geographical coordinates).

According the cosine theorem of the spherical geometry

cosD1=sinl1.sinlx+cosl1.coslx.cos(L1-Lx)

cosD2=sinl2.sinlx+cosl2.coslx.cos(L2-Lx)

While according the cosine theorem of the plane geometry

$$\begin{matrix}{d1}^{2} = {r1}^{2} + {rx}^{2} - 2 \cdot r1 \cdot rx \cdot cos D1 \\ {d2}^{2} = {r2}^{2} + {rx}^{2} - 2 \cdot r2 \cdot rx \cdot cos D2\end{matrix}$$

Being known d1-d2, subtracting the d1 and d2 of the previous ecuations, the hyperboloid ecuation H12 is obtained.

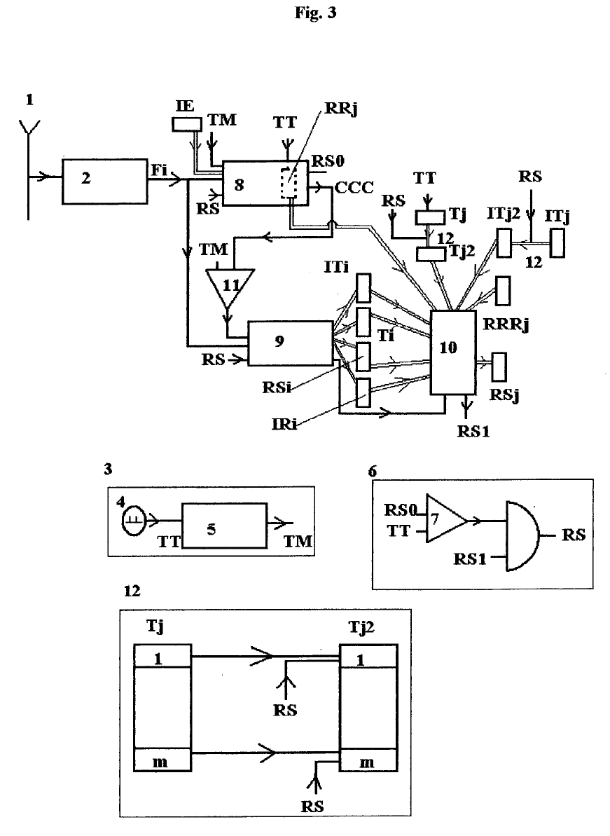

FIG. 3. Synchronization circuit of a satellite.

The satellite Rj receives the synchronization signal from the satellite Ri through a radio-receiver 1 and a demodulator 2, giving Fi which enters a signal identifier circuit 8 and a sampling circuit 9.

The puse RS1 from a cumputer 10 informs that the system is ready to receive data. RS1 is changed into RS through the circuit 6. This RS performs the following jobs:

starting the signal identifier circuit 8 and the sampling circuit 9,

fixing the record of Tj y ITj in the record Tj2 y ITj2 with the circuits 12, each Tj2 y ITj2 is constant until new RS.

Each circuit 12 is a set of parallel links between for example the memory devices Tj and Tj2. These memory devices Tj2 could be flip-flop DELAY type, being the input clock of said flip-flop the pulse RS.

The identifier circuit 8 verifies that the initial bits of Fi match with a record IE. By this a sampling signal TM is used. If nom-verification, a signal RS0 is sent the circuit 6 which emits the pulse RS, re-starting the proccess. If verification, a signal CCC is sent. This identifier circuit has a counter RRj controlled by the two last bits of IEi (10). This counter uses the clock signal TT. Also, this identifier circuit is started by the pulse signal RS.

The sampling circuit 9 is controled by the sampling signal TM which only acts if the signal CCC=1 (by the AND door 11). This sampling circuit changes the serial bits of Fi (IT, T, RS and IR) into the parallel bits of the records ITi, Ti, RSi and IRi, then the sampling circuit emits a signal to inform the computer 10 that a set of data is ready.

The computer 10 obtains RSj with the value of the records ITi, Ti, RSi, IRi, RRj, Tj2, ITj2 and RRRj:

RSj=Ti+RSi+IRi+|ITi−ITj2|/c−(Tj2+RRj+RRRj)

TM could be obtained from TT according the circuit 3, being 4 the clock of the pulses TT and 5 an pulses divider circuit.

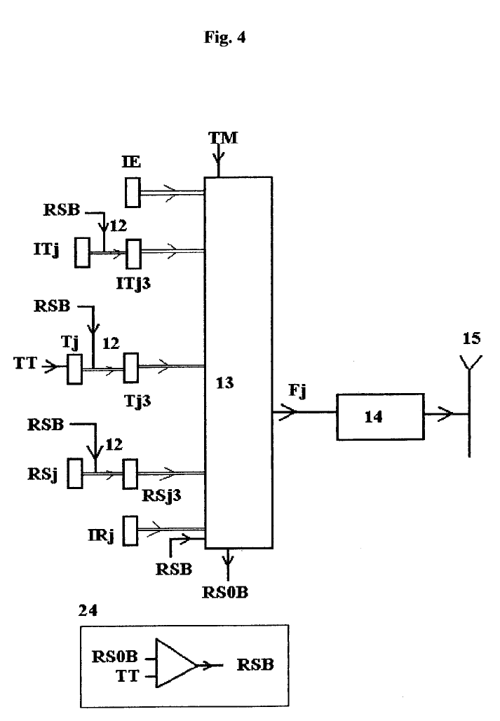

FIG. 4. Formation circuit of the satellite signal.

The satellite j emits the signal Fj thruogh a modulator 14 and an emitter 15, being obtained Fj from the sequencer 13.

A signal RS0B from said sequencer 13 informs that the system is ready to send a new set of data, being changed this signal RS0b in a pulse RSB through the circuit 24. This pulse RSB fixes the record Tj, ITj y RSj on the record Tj3, ITj3 and RSj3 by mean of the 12, each Tj3, ITj3 and RSj3 is constant until new pulse RSB.

The pulse RSB also starting the sequencer 13, begining to transform the parallel record IE, ITj3, Tj3, RSj3 and IRj into the serial signal Fj.

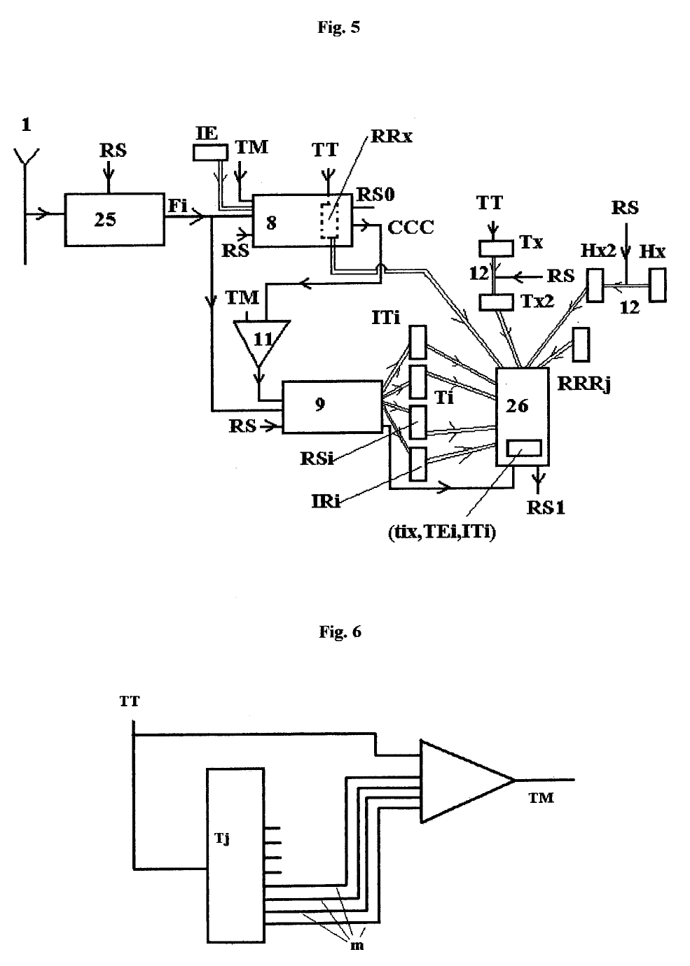

FIG. 5. Data captator circuit of a mobile.

This circuit is very similar the circuit of the FIG. 3, being the differences:

the demodulator 25 is controlled by the pulses RS, changing the tuner frequency,

a computer 26 obtains the essential data set of each measure (tix, TEi,ITi), storing said data set into the computer memory,

ITx2 is not an input data of the computer 26, being a input data the altimeter Hx.

The computer 25 stores the data sets until said computer reaches the neccessary number of measures to calculate the position of X.

FIG. 6. Pulses divider circuit.

The m less significant bits of a counter which is actuates by the signal TT (for example the record Tj of the FIG. 3) are entered an AND door. The exit of said AND door is the pulse signal TM:

$$TT = TM / {2}^{m}$$

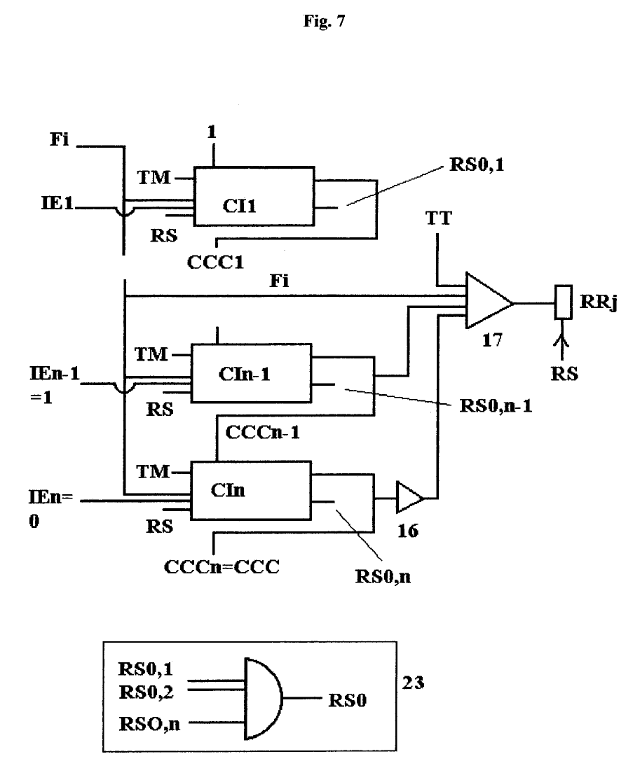

FIG. 7. Signal identifier circuit.

The field IE has n bits, the last two bits ever are 10.

The bites IE1, . . . , IEn are identified with the basic comparator circuits CI1, . . . , CIn. Each CIk receives its IEk, the sampling signal TM, a signal CCCk-1 from the previous basic comparator circuit CIk-1 informing which the previous IEk-1 has been identified, and the pulse RS. Each DIk giving the signal CCCk if IEk has been identified or RS0k if IEk has not been identified.

All the RS01, . . . , RS0n enter an OR door, exiting the only non identification signal RS0 (circuit 23).

The record RRj are actuated by the pulses TT, but only when CCCn-1=1, Fi=1 and CCCn=0 (see AND door 17).

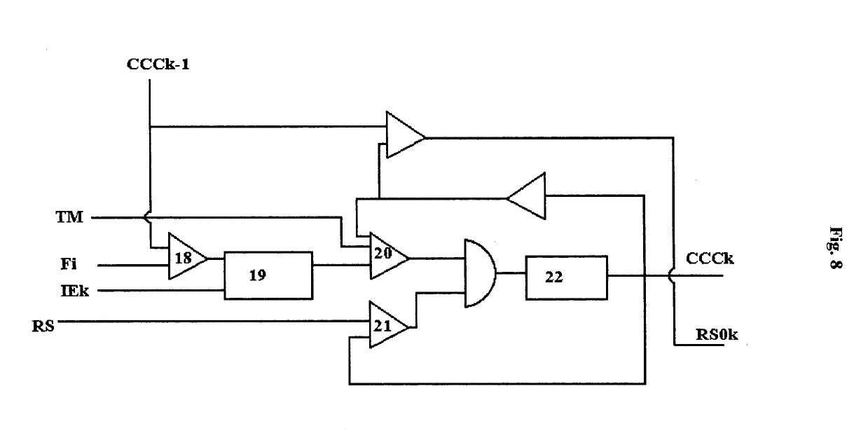

FIG. 8. Basic comparator circuit.

When CCCk-1=1, an AND door 18 permits the signal Fi to access the comparator 19. If the exit of the comparator is 1, when one pulse TM actuates an AND door 20, a flip-flop 22 changes its outlet 0 for 1. Due the AND door 21 the flip-flop 22 is started when the pulse RS.

The flip-flop is a JK type, T mode.

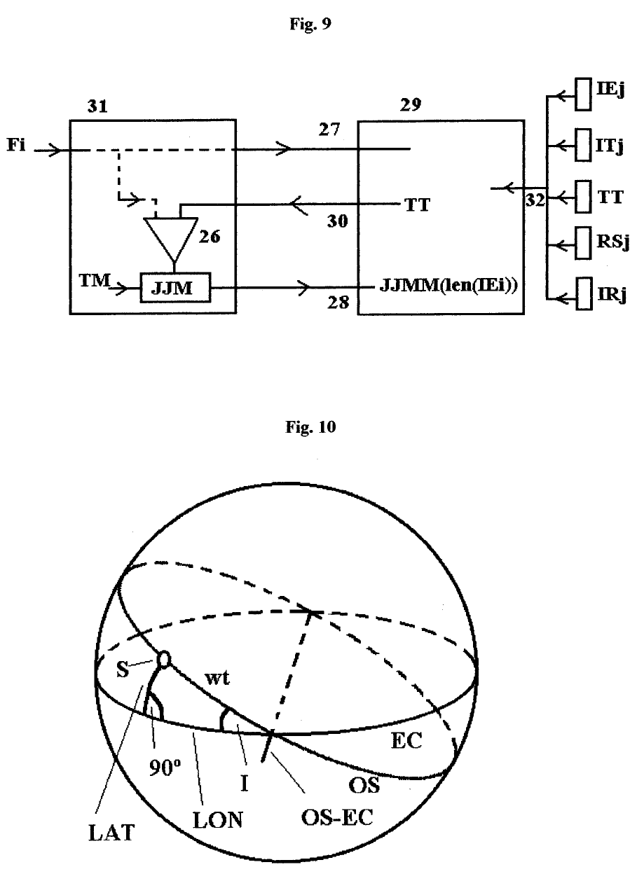

FIG. 9. The computer-controlled system.

All the said records (excepted RRj) could be memory variables of a computer 29.

At the begining of the proccess, the computer defines a numerical array RRMM, dimension len(IEi)=n, to contain the data from the record RRM of a modem 31.

Fi enters the modem 31, being re-sends the computer 29 through the serial port 27. Also Fi and TT from the computer through a second serial port 30 enter an AND door 26, while the outlet of said AND door 26 actuates the counter RRM. This counter RRM is started by the signal TM of the modem. Fulthermore, the signal TM sends RRM to a parallel port 28, then the computer shifts the array RRMM, inputing RRM at RRMM(1).

The computer makes the signal Fj according the valures of the devices IEj, . . . , Irj, being connected said devices to a local network 32.

When the modem informs te computer 29 which one bit will be transmited

the computer receives the bit by the serial port,

the computer puts the last bits in the memory variables IEi, . . . , IRi,

if IEi=IEj there is a correct set of data, calculating RRj=min(RRMM(1), . . . , RRMM(len(IEi)),

if IEi⋄IEj the computer waits another bit from the modem, starting a new cycle.

So the function of the identifier circuit has been performed by a sentece type

IF IEi⋄IEj (to receive other bit) ELSE (to continue calculation).

Furthermore, the modem would be modified to change its frequency of modulation-demodulation continuosly into a fixed bandwidth, according with computer orders.

A specific port could be designed, having said port the performances of the two serial port and the parallel port.

FIG. 10. Satellite sky projection.

The FIG. 10 shows the geometrical spherical problem. The satellite S on the orbit OS being its radius regarding the earth center equal that the geostationary satellites, the intersection of the OS with the ecuator plane EC is an fixed axe OS-EC and the angle of the planes OS and EC is a fixed angle I less that 90°. Having in account said performances, easyly can be calculated the latitude LAT and longitude LON of the satellite regarding the sky sphere in at time, solving the spherical triangle characterized by the angles I, wt and 90°, being w=360°/24h.

Said sky coordinates are changed terrestrial coordinates by the ecuations:

Terrestrial LAT=Sky LAT

Terrestrial LON=Sky LON-wt

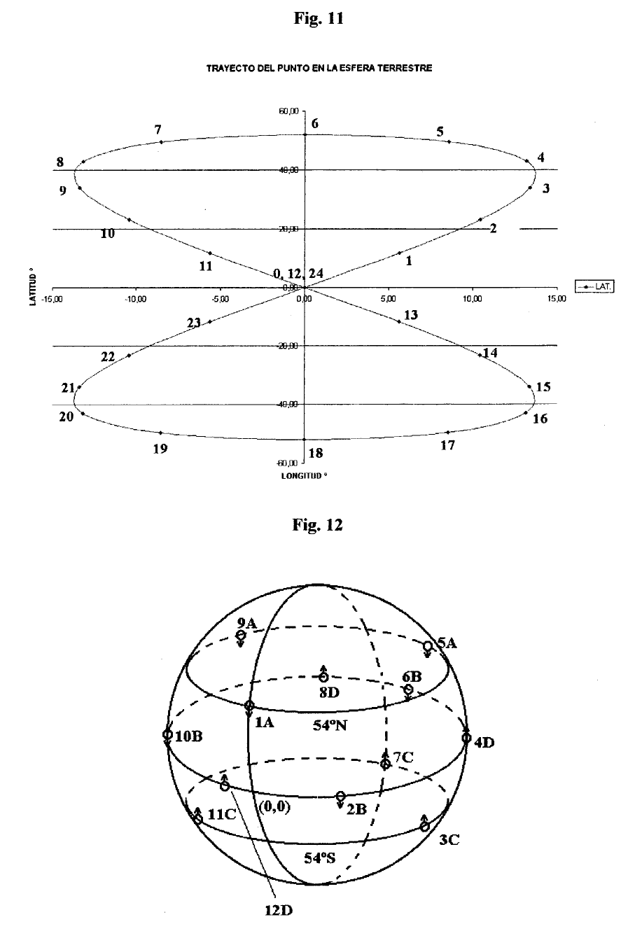

FIG. 11. The movement of the satellite regarding the earth.

A simple proyection is used:

x=terrestrial longitude

y=terrestrial latitude.

The movement of the satellite looks as a regular movement as a “8”, raising/falling between +/− a maximal latitude (maximal latitude of the satellite), around an average meridian (longitude of the satellite)

FIG. 12. Satellite fleet with 3 satellites/constellation.

At the time that the first satellite is at its maximal latitude:

| Satellite | Constelatiòn | Latitude | Longitude | Sense |
|---|---|---|---|---|
| 1 | A | 54 | 0 | South |
| 2 | B | 0 | 30 | South |
| 3 | C | −54 | 60 | Nort |
| 4 | D | 0 | 90 | Nort |
| 5 | A | 54 | 120 | South |
| 6 | B | 0 | 150 | South |
| 7 | C | −54 | 180 | Nort |
| 8 | D | 0 | 210 | Nort |
| 9 | A | 54 | 240 | South |
| 10 | B | 0 | 270 | South |
| 11 | C | −54 | 300 | Nort |
| 12 | D | 0 | 330 | Nort |

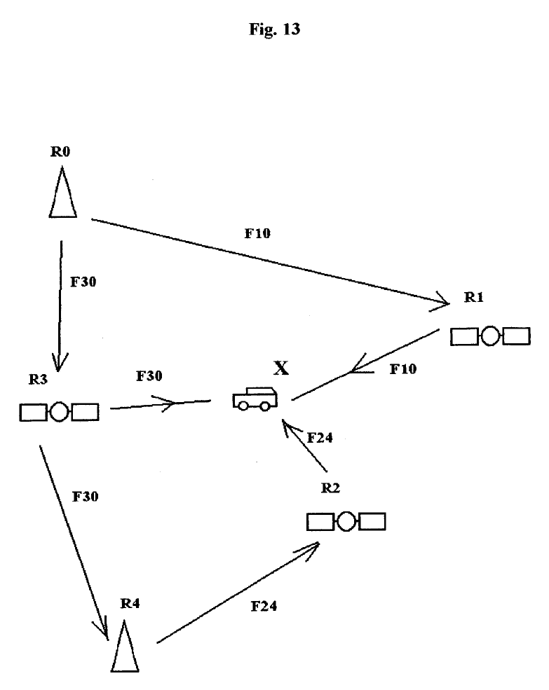

FIG. 13. Signals from the radiolocalization system for radiorepeater satellites.

This figure shows the terrestrial radiostation R0 feeding the satellites R1 and signals R3 with the signals F10 and F30, while the satellite R3 syncrhonizes the terrestrial radiostation R4 with the repeater signal F30.

Naturally, the synchronization circuits and the formation of signal circuits are into the trial radiostation.

1. A method for the radiolocalization of a mobile, the mobile receiving modulated radiolocalization signals from at least three visible satellites, the mobile and each satellite provided with a radiostation, each signal containing the position and the time of the emitter satellite, each signal defining a surface or line where the mobile would be located, comprising
orbiting each satellite on an orbit with a radius equal to a geostationary orbit and an angle regadind the terrestrial ecuator less that 90°,
measuring in each satellite a global time by adding a local time of the satellite and a synchronization delay,
synchronising each satellite with the radiolocalization signal from other satellite by modifying the synchronization delay of the sinchonized satellite according with the global time of the radiolocalization signal+transit time between the synchronizer and synchronized satellites-local time of the synchronized satellite,
receiving in the mobile consecutively the three radiolocalization signals,
calculating in the mobile a revolution hyperboloid from the data of two signals,
measuring in the mobile an altitude from the sea top,
calculating in the mobile the sphere radius earth radius+mobile altitude,
calculating in the mobile the tangent spheres with minimal radius to combinations without repetition of four surfaces, each surface one hyperboloid or the sphere, and choosing the correct solution by having in account the time differences between the satellites,
calculating the mobile position mediating all the previously calculated positions.

2. The method of the claim 1 when the satellite radiostation is a repeater circuit characterized in repeating the satellite a radiolocalization signal from a terrestrial radiostation, while the terrestrial radiostation calculates the data of said radiolocalization signal at the time of the repetition by the satellite.

3. The method of the claim 2 characterized in synchronizing some terrestrial radiostation from the repeated radiolocalization signals from the satellites.

4. The method of the claim 2 characterized in synchronizing some terrestrial radiostation from another terrestrial radiostation by mean of a direct radiolocalization signal.

5. The method of the claim 1 when the radiolocalization signal is a binary signal and the time are from a pulse clock, comprising
sampling or sequencing each radiolocalization signal with a pulse sampling signal, the sampling signal period bigger that the clock period,
identifiying each radiolocalization signal by mean of a common emission identifier field being its two last bits 10,
measuring an arrival delay due the difference between the sampling signal period and the clock period when the last two bits of the emission identifier field 10 are identified.

6. The method of the claim 1, characterized in obtaining in the mobile more position by solving all the ecuation systems of combinations without repetition of three surfaces, each surface one hyperboloid or the sphere, and choosing the correct solution by having in account the time differences between the satellites.

7. The method of the claim 1 characterized in emitting in the same frequency two satellites when the reception zone of the earth from one satellite is a shade zone regarding the other satellite.

8. The method of the claim 1 characterized in syncrhonising some satellites from terrestrial radiostation by emitting radiolocalization signals similar to the satellites.

9. The method of the claim 1 characterized in
putting the satellites in four constellations, having the satellites of each constellation the same latitude at time,
inserting the satellites of all the constellations, with the same difference of geographical longitude,
raising to the Nort the constellation with latitude<−9°,
raising to the Nort the constellation with 9°<latitude<−9°,
falling to the South the constellation with latitude>9
falling to the South the other constellation with 9°>latitude>−9°.

10. The method of the claim 9 characterized in syncronising each satellite with the previous satellite in geographical longitude.

11. The method of the claim 9 characterized in syncronising some satellites from terrestrial radiostations, and the rest from the previous satellite.

12. A system for the radiolocalization of a mobile, the mobile receiving modulated radiolocalization signals from at least three visible satellites, the mobile and each satellite provided with a radiostation, each signal containing the position and the time of the emitter satellite, each signal defining a surface or line where the mobile would be located, comprising
a satellite on an orbit having a radius equal to a geostationary orbit and an angle regadind the terrestrial ecuator less that 90°,
a pulse sampling signal and a pulse clock signal, the sampling signal period bigger that the pulse clock period,
binary signal of radiolocalization having a common emission identifier field, being its last two bits 10,
the radiolocalization signals also are synchronization signals,
in each satellite, a synchronization circuit with a signal identifier circuit, the last with a record to contain an arrival delay, according the two last bits of the common emission identifier field,
in the mobile a data captator circuit with another signal identifier circuit, the last with another record to contain another arrival delay, according the two last bits of the common emission identifier field,
in the mobile an altimeter,
the synchronization circuit and the data captator circuit receive the radiolocalization signal, the sampling signal and the clock signal,
the radiolocalization signals also having the fields of emitter geography coordinates, emitter local time, emitter synchronization delay and emission delay,
in each satellite, means to obtain the values of the fields of the radiolocalization signal, storage record for the fields of the radiolocalization signal at the times of emmiting and receiving the radiolocalization signal,
a formation signall circuit from the storage record,
the formation signall circuits receive the sampling signal.

13. The system of the claim 1 when the satellite radiostation is a repeater circuit characterized in that
a repeater signal of the satellite is a radiolocalization signal from a terrestrial radio station,
the synchronization circuits, the means to obtain the values of the fields of the radiolocalization signal, the storage record for the fields of the radiolocalization signal and the formation signall circuits are in the terrestrial radio station.

14. The system of the claim 12 characterized in that the sampling signal is obtained from the clock signal by mean of a pulses divider circuit comprising an AND door having as input the clock signal and the less significant bits from a counter actuated by the clock signal.

15. The system of the claim 12 characterized in that the storage record is a set of DELAY flip-flops which are parallel to the mean with the values of the fields of the radiolocalization signal, being actuates this flip-flops by a starting signal.

16. The synchronization circuit of the claim 12, comprising
a demodulator,
the signal identifier circuit having the outputs of a first conformity signal if the radiolocalization signal is identified, a starting signal if the radiolocalization signal is not identified, and a record of the arrival delay
a sampling circuit actuates by the sampling signal when the first conformity signal=1, said sampling circuit changes the serial fields emitter geography coordinates, emitter local time, emitter synchronization delay and emission delay into four parallel records, then, when the sampling circuit has finished is set a second conformity signal,
a computer is actuated when the second conformity signal=1, said computer get the values of the fields emitter geography coordinates, emitter local time, emitter synchronization delay and emission delay, now in parallel records, an arrival local time, a receiver delay and a receiver geography coordinates,
the computer actuates a record to contain the synchronization delay, setting the starting signal.

17. The data captator circuit of the claim 12 comprising
a pulse demodulator, changing the tuner frequency when is actuates by a starting signal,
the signal identifier circuit having the outputs of a first conformity signal if the radiolocalization signal is identified, a starting signal if the radiolocalization signal is not identified, and a record of the arrival delay,
a sampling circuit actuates by the sampling signal when the first conformity signal=1, said sampling circuit changes the serial fields emitter geography coordinates, emitter local time, emitter synchronization delay and emission delay into four parallel records, then, when the sampling circuit has finished is set a second conformity signal, p1 a computer is actuated when the second conformity signal=1, said computer get the values of the fields emitter geography coordinates, emitter local time, emitter synchronization delay and emission delay, now in parallel records, an arrival local time, a receiver delay and the altimeter,
the computer calculates and stores the arrival local time of the radiolocalization signal, the emitter global time and the emitter geograpy coordinates of the emitter satellite, setting the starting signal,
the computes calculates the mobile position when the computer has stored sufficient data.

18. The formation signall circuit of the claim 12 comprising a sequencer to change the parallel values of the storage records for the fields of the radiolocalization signal at the time of emiting the radiolocalization signal into the serial radiolocalization signal, then the sequencier emits a starting signal to actuate the same sequencer and the storage records, being sent the serial radiolocalization signal to a modulator, and being emitted.

19. The identifier circuit of the claims 16 or 17 comprising
so basic comparator circuits as the bits of the common emission identifier field, each basic comparator circuit having a bit conformity signal and a bit starting signal, being actuates by the bit conformity signal from the previous basic comparator circuit and the sampling signal,
the last bit conformity signal is the conformity signal of the identifier circuit,
the starting signal of the identifier circuit is the outlet of an OR door, being the input of the OR door all the bit starting signals,
the record of the arrival delay is a counter actuated through an AND door by the clock signal, the penultimate bit conformity signal and the output of a NOT door from the ultimate bit conformity signal.

20. The basic comparator circuit of the claim 19 comprising a bit comparator circuit, a flip-flop with its starting circuit, while a first AND door avoids the comparison before the bit conformity signal from the previous basic comparator, and a second AND door actuates by the sampling signal transmits the output bit comparator circuit to the flip-flop.

21. The radiolocalization system of the claim 12 comprising
in each satellite and the mobile, a computer,
in each satellite and the mobile, a receiver modem,
in each satellite an emitter modem,
the means to obtain the values of the fields of the radiolocalization signal are devices connected to a local network,
the receiver modem having connection with the computer through a first and a second serial port and a parallel port,
the sampling signal is from the modems,
the clock signal is from the computer,
the receiver modem containing a counter actuates from an AND door, said AND door having as inputs the radiolocalization signal and the computer clock through the second serial port, said counter being started by the sampling signal of the receiver modem, the counter value is transmitted to the computer through the parallel port to calculate the arrival delay,
each modem with a continous modulation-demodulation range of frequencies into the radiolocalization bandwidth, accoding to orders from the computer,
the storage records are memory variable,
the synchronization circuit, the formation signal circuit and the data captator circuit are changed by computer programs.

22. An use of the satellites for telephony and for television for radiolocalization characterized in repeating radiolocalization signal from a terrestrial radiostation.
